(19) United States
(12) Patent Application Publication
(10) Pub. No.: US 2026/0186947 A1
(43) Pub. Date: Jul. 2, 2026

(54) SYSTEMS AND METHODS FOR MACHINE LEARNING-BASED EXECUTION OF SOFTWARE CODE FROM SCIENTIFIC OR TECHNICAL DOCUMENTS IN A SECURE COMPUTING ENVIRONMENT

(71) Applicants: Constructor Technology AG, Schaffhausen (CH); Constructor Education and Research Genossenschaft, Schaffhausen (CH)

(72) Inventors: Alexander Tormasov, Busingen am Hochrhein (DE); Andrey Adashchik, Istanbul (TR); Sergey Ulasen, Singapore (SG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/003,889

(22) Filed: Dec. 27, 2024

(51) Int. Cl. G06F 11/3604

(52) U.S. Cl. CPC G06F 11/3608

(57) ABSTRACT

Disclosed herein are systems and method for machine learning (ML)-assisted analysis of scientific or technical documents and associated software code, the method comprising: retrieving a scientific or technical document and a software code associated with the scientific or technical document, the software code including executable code and/or source code; analyzing the scientific or technical document using a trained paper analysis ML model configured to identify subject matter, logic, algorithms, and/or parameters of the scientific or technical document; analyzing the software code using a trained software analysis ML model configured to identify subject matter, logic, algorithms, and/or parameters of the software code; and comparing the algorithms and parameters of the scientific or technical document with the algorithms and parameters of the associated software code to identifying corresponding algorithms and parameters in the scientific or technical document and the software code.

### FIELD OF TECHNOLOGY

The present disclosure relates to the field of machine learning, and, more specifically, to systems and methods for machine learning (ML)-assisted analysis of scientific or technical documents and associated software code.

### BACKGROUND

In the rapidly evolving landscape of setting up computing environments for academic projects, the traditional approach of manually linking scientific articles and their accompanying code or computational workflows is proving to be increasingly ineffective and cumbersome. The traditional approach is typically time-consuming and requires careful attention to detail to ensure that the computing environment is properly configured and that there is a clear correspondence between parameters mentioned in the scientific text and those used in the software code for analysis.

As an example workflow, take a researcher working on replicating a deep learning experiment based on a scientific article that describes a convolutional neural network (CNN) for classification. First, the researcher must review the scientific article to identify key parameters and to understand the computational processes and techniques applied in a methods section of the scientific article. In this way, the researcher manually extracts information from the article describing the architecture of the CNN (e.g., number of layers, types of activation functions, etc.) as well as training parameters like batch size, learning rate, and the dataset used. Next, the research must locate and install software and tools, and any other required libraries by following instructions. The researcher may use a virtual environment to manage dependencies. This requires the researcher to inspect the code to find the variables and configurations that correspond to the descriptions in the paper. Parameters such as initial conditions, learning rates, or iteration counts may be manually adjusted in configuration files or script headers to match the experimental setup described in the article. This ensures that the code matches the experimental conditions described in the text. In addition, scientific research often involves specific datasets (e.g., publicly available data, proprietary data, or data generated through experiments). The research again must manually download and preprocess these datasets to ensure they align with the conditions described in the article.

After setting up the environment and configuring the parameters, the researcher runs the experiment or analysis. This is often done iteratively, with trial and error required to identify issues like missing dependencies, incorrect paths, or mismatches between the code and the experiment described in the article. These should be modified in the code to match the article's descriptions. The experiment is then run on local hardware ensuring that the same dataset is used. Finally, the results are compared to the findings in the article. If the results still differ significantly, the researcher may need to iterate over the parameters, manually troubleshoot the steps, or even contact the authors for clarification.

Challenges of the traditional approach involve time-intensive steps in setting up the computing environment, locating the right software and codebase, and configuring the code manually. In addition, with the handling of dependencies, configurations, and parameter tuning, there is a high potential for human error, which can lead to irreproducible results. Another challenge may be a lack of standardization since every researcher may have their own way of setting up environments, which can lead to inconsistencies in how experiments are run and results are generated. Finally, it may be difficult to reproduce results—particularly, if the scientific article lacks detailed descriptions of the environment, versions, and specific parameter configurations.

The traditional approach of setting up computing environments for scientific research projects involves manually interpreting the article, locating and installing the necessary tools, mapping parameters from the text to the code, and iteratively configuring the environment for experimentation. This process, while flexible, is highly time-intensive, error-prone, and often lacks the standardization required for seamless reproducibility.

### SUMMARY

To address the shortcomings of implementing a suitable computational environment to run code attached to a scientific article, the present disclosure describes training machine learning models to automatically build a suitable computational environment to execute software code attached to scientific article. Specifically, the present disclosure describes automating the setup of computing environments tailored for scientific research projects by leveraging artificial intelligence (AI) models to efficiently select and configure the necessary tools, resources, and parameters to validate the results and methods in the scientific article. Some of the technical improvements of the present disclosure include creating a correspondence between parameters in the text of the article and parameters in the attached code for reconfiguration and analysis, including the ability to easily manage and change parameters within the attached software code.

In one exemplary aspect, a method for ML-based execution of software code from scientific or technical documents in a secure computing environment, the method including: retrieving a scientific or technical document and a software code associated with the scientific or technical document, wherein the software code comprises executable code and/or source code; analyzing the scientific or technical document for scientific features including at least one of parameters, subject matter, logic, or an algorithm using a trained paper analysis ML model configured to identify the scientific features represented in the scientific or technical document; obtaining a description of the identified scientific features represented in the scientific or technical document from external sources; analyzing the software code to identify corresponding scientific features from the scientific or technical document in the software code using a trained software analysis ML model configured to identify the corresponding scientific features represented in the analyzed software code based on the obtained description of the identified scientific features represented in the scientific or technical document; and displaying, in a user interface, the identified corresponding scientific features from the scientific or technical document and the software code.

In one aspect, identifying the corresponding scientific features represented in the analyzed software code is based at least in part on searching for scientific features in the software code using the trained software analysis ML model.

In one aspect, searching for scientific features in the software code further includes: obtaining partial algorithms in the scientific or technical document and the software code; identifying scientific features in the partial algorithms in the software code that are similar to the identified scientific features of the partial algorithms in the scientific or technical document; juxtaposing the scientific features found in the partial algorithms in the scientific or technical document and in the partial algorithms in the software code; and determining similarities between the scientific features found in the partial algorithms in the scientific or technical document and partial algorithms in the software code.

In one aspect, searching for scientific features in the software code further comprises: benchmarking the results of the search and displaying a level of confidence corresponding to a similarity of each identified methodology feature represented in the software code with the identified methodology feature represented in the scientific or technical document.

In one aspect, the method further includes: identifying corresponding parameters in the scientific or technical document and the software code by juxtaposing the scientific features of the scientific or technical document with the features of algorithms and parameters of the associated software code; and causing, in a user interface, a display of at least the identified corresponding parameters in the scientific or technical document and the software code.

In one aspect, the method further includes: analyzing the scientific or technical document using a trained paper analysis ML model configured to identify subject matter, logic, algorithms, and/or parameters of the scientific or technical document; and analyzing portions of the software code using a trained software analysis ML model configured to identify subject matter, logic, algorithms, and/or parameters represented in the portions of the software code, wherein the portions of the software code are identified based on the external sources.

In one aspect, the method further includes displaying the description of the subject matter, logic, algorithms, and/or parameters from external sources.

In one aspect, the algorithms and parameters of the scientific or technical document includes at least data sets, equations and parameters of the equations and the algorithms and parameters of the software code include data structures, functions and variable of the functions.

In one aspect analyzing the software code further includes: generating a secure virtual environment configured to execute software code; and executing the software code in the secure virtual environment.

In one aspect, the secure virtual environment includes one of a virtual machine, a container, a docket container, or a sandbox.

In one aspect, executing the software code includes: retrieving and utilizing one or more software libraries for the execution of the software code.

In one aspect, executing the software code comprises: checking the software code for malware and/or security vulnerabilities; and, based on a determination that the software code contains malware and/or serious security vulnerabilities, terminating execution of the software code.

In one aspect, the method further includes: preparing the paper analysis ML model based on a text interpretation large language model to identify different subjects, parameters, and/or logic using one or more other scientific or technical documents from a scientific or technical document database.

In one aspect, the method further includes: preparing the software analysis ML model to identify different subjects, parameters, and/or logic using one or more software code from a code database.

In one aspect, identifying the correspondence between the software code and the scientific or technical document further comprising: preparing and executing an assessment ML model to perform the assessment of correspondence to the scientific or technical document, based on a training dataset comprising scientific or technical documents and corresponding software code, and to generate text explaining the results of the comparison using a text generation model.

In one aspect, assessing whether the software code corresponds to the scientific or technical document further includes: extracting algorithms from the scientific or technical documents and corresponding software code; marking parameters from the scientific or technical documents related to specific steps of the extracted algorithm; combining the algorithms from the scientific or technical documents and the algorithms from the corresponding software code into prompts for the trained assessment ML model; and determining correspondences between the extracted parameters and corresponding values from text of the scientific or technical documents and parameters and corresponding values from the corresponding software code using the trained assessment ML model.

In one aspect, the method further includes: displaying, in the user interface, parameters in the software code using a visual indicator configured to accept, deny, or edit correspondence.

In one aspect, the method further includes: obtaining a modification of at least one parameter in the software code; and executing the software code with the modified at least one parameter.

In one aspect, the method further includes: allowing a user to change parameters in the software code.

According to one aspect of the disclosure, a system is provided for machine learning (ML)-based execution of software code from scientific or technical documents in a secure computing environment, the system including: at least one memory; and at least one hardware processor coupled with the at least one memory and configured, individually or in combination, to: retrieve a scientific or technical document and a software code associated with the scientific or technical document, wherein the software code comprises executable code and/or source code; analyze the scientific or technical document for scientific features including at least one of parameters, subject matter, logic, or an algorithm using a trained paper analysis ML model configured to identify the scientific features represented in the scientific or technical document; obtain a description of the identified scientific features represented in the scientific or technical document from external sources; analyze the software code to identify corresponding scientific features from the scientific or technical document in the software code using a trained software analysis ML model configured to identify the corresponding scientific features represented in the analyzed software code based on the obtained description of the identified scientific features represented in the scientific or technical document; and cause, in a user interface, a display of the identified corresponding scientific features from the scientific or technical document and the software code.

In one exemplary aspect, a non-transitory computer readable medium storing thereon computer executable instructions for machine learning (ML)-assisted analysis of scientific or technical documents and associated software code, including instructions for: retrieving a scientific or technical document and a software code associated with the scientific or technical document, wherein the software code comprises executable code and/or source code; analyzing the scientific or technical document for scientific features including at least one of parameters, subject matter, logic, or an algorithm using a trained paper analysis ML model configured to identify the scientific features represented in the scientific or technical document; obtaining a description of the identified scientific features represented in the scientific or technical document from external sources; analyzing the software code to identify corresponding scientific features from the scientific or technical document in the software code using a trained software analysis ML model configured to identify the corresponding scientific features represented in the analyzed software code based on the obtained description of the identified scientific features represented in the scientific or technical document; and causing, in a user interface, a display of the identified corresponding scientific features from the scientific or technical document and the software code.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for analyzing scientific or technical documents and associated software code using machine learning according to aspects of the present disclosure.

FIG. 2 is a block diagram illustrating a system for training machine learning models to identifying logic, algorithms, and/or parameters of scientific or technical documents and associated software code according to aspects of the present disclosure.

FIG. 3 is a first flow diagram of a method for machine learning (ML)-based analysis of scientific or technical documents and associated software code according to aspects of the present disclosure.

FIG. 4 is a second flow diagram of a method for machine learning (ML)-based analysis of scientific or technical documents and associated software code according to aspects of the present disclosure.

FIG. 5 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for machine learning (ML)-based execution of software code from scientific or technical documents in a secure computing environment. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present describes various aspects of machine learning (ML)-based execution of software code from scientific or technical documents in a secure computing environment. One aspect involves using machine learning to analyze a scientific or technical document to identify subject matter, parameters, and/or logic of the scientific or technical document. A second aspect involves using machine learning to analyze software code associated with the scientific or technical document to identify the subject matter, parameters, and/or logic of the software code. A third aspect involves using machine learning to use a text interpretation large language model (LLM) to identify different subjects, parameters, and/or logic using one or more other scientific or technical documents from a database. A fourth aspect involves using a machine learning model to assess whether the software code corresponds to the scientific or technical documents and generating text explaining results of the comparison using a LLM.

A scientific or technical document may have software code associated with it for several reasons, depending on the nature of the research and its field. A fundamental principle of scientific research is reproducibility, which requires that other researchers can replicate the results presented in a study. Sharing computer code fosters transparency, allowing others to verify the findings or expand upon the research. In many scientific and engineering disciplines, researchers may use complex models and simulations that are developed as part of the study. Providing the software code also ensures that other researchers can run these simulations under similar conditions to understand the models better, validate the results, or test them against different datasets. In addition, many scientific or technical documents may involve the analysis of large datasets. Computer code may be provided to show how data was processed, analyzed, or visualized. Furthermore, code associated with scientific or technical documents provides a reference for how the authors implemented a particular algorithm or method. This is particularly important in cases where the method's details may be too complex to describe fully in text, or where small differences in implementation might significantly affect the results. It should be noted that the invention is not limited to scientific or technical documents, but includes any type of research paper, or the like.

However, validating software code associated with scientific or technical documents presents a number of challenges.

First, the manual setup of computing environments is time-consuming and prone to user errors, especially when researches (who may not have a technical background or experience in computer programming) need to identify and install the correct tools, libraries, and dependencies. Automation streamlines this process, allowing researchers to focus on the core scientific tasks instead of setting up and configuring the computing environment. By automating the setup and implementation of computing environments, researches may easily and reliably recreate computing environments. In this way, collaboration and sharing of results may be accelerated, ensuring that the research described in the scientific or technical documents can be easily replicated by others.

Second, automation guarantees that the same environment is set up consistently, reducing variability between experimental runs due to mismatched software versions or configuration errors. Automated setup systems can ensure that all experiments adhere to certain standards or protocols, increasing the scientific rigor of the research. Software code may be written in a specific environment (e.g., specific operating systems, libraries, or versions of dependencies), and without detailed documentation. Variations in hardware or software configurations may lead to inconsistent results.

Third, leveraging AI to select and configure the necessary tools ensures that only the essential resources are deployed, optimizing computational resources and reducing waste. For example, AI can determine the best cloud instances, hardware accelerators (GPUs or TPUs) or storage solutions for specific tasks. AI may dynamically adjust the computational resources or parameters based on project requirements or ongoing experimental needs, improving the efficiency of high-performing computing environments.

Fourth, modern research, particularly in fields like genomics, astrophysics, and AI, often involves large-scale datasets and complex computational workflows. AI-driven automation can streamline and orchestrate these workflows, ensuring that all dependencies are met and the correct parameters are applied to each stage of the analysis. As machine learning and AI become central to many fields, automated setups can ensure that the necessary machine learning frameworks (e.g., TensorFlow, PyTorch) and libraries (e.g., SciPy, Pandas) are correctly configured, reducing the burden on researchers unfamiliar with these tools.

Finally, manual setup is prone to mistakes, such as missing dependencies, wrong library versions, or misconfigured environments. Automating the setup, especially with AI's ability to intelligently manage configurations, reduces the likelihood of such errors, improving the reliability of experiments. AI systems can also detect misconfigurations or performance bottlenecks during setup, offering suggestions or making automatic adjustments to optimize the environment.

Automating the setup of computing environments for scientific research, especially when combined with AI for tool selection and parameter management, enables faster, more reliable, and more scalable research. It enhances reproducibility, optimizes resource usage, facilitates collaboration, and ensures that experiments are conducted in well-tuned, error-free environments. This kind of automation is increasingly essential in modern scientific inquiry, where complexity, data, and computational demands continue to grow exponentially.

It should be noted that the present disclosure describes utilizing a computing environment for analyzing research projects based on scientific articles for illustrative purposes only and that the methods and systems described in the present disclosure may be applicable to any activity that involves comparing logic, parameters, and/or algorithms between an academic paper and computer code. As a non-limiting example, the methods and systems described in the present disclosure may be applicable to business papers and computer code.

Turning now to the figures, example aspects are depicted with reference to one or more components described herein, where components in dashed lines may be optional.

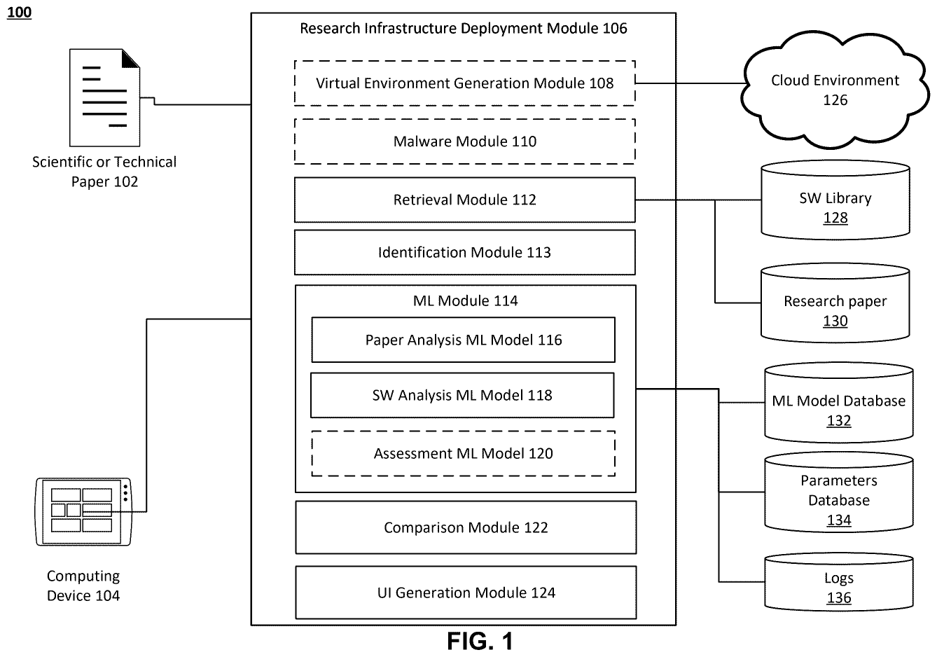

FIG. 1 is a block diagram illustrating a system 100 for analyzing scientific or technical documents and associated software code using machine learning according to aspects of the present disclosure. The system 100 may include a computing device 104, a scientific or technical document 102, and a research infrastructure deployment module 106, which may be a software installed on or accessed (e.g., via a virtual machine, container, web application) on the computing device 104. The computing device 104 allows for a user to control and configure the system 100 and view a UI. Computing device 104 may execute a plurality of modules in the research infrastructure deployment module 106 that together make up a retrieval, recognition, and analysis system. In some aspects, the research infrastructure deployment module 106 may correspond to a computing device 104 that is configured to execute a plurality of modules that together make up the research infrastructure deployment module 106.

Sharing software code in scientific or technical documents is a way to promote transparency, reproducibility, and collaboration, making it easier for the scientific community to validate, extend, or apply the research. It's particularly common in disciplines involving computational methods, data analysis, and software development. The research infrastructure deployment module 106 may be configured to build a suitable computational environment to run software code associated with a scientific or technical document 102 in order to validate the parameters, logic, methods, and/or results in the scientific or technical document 102.

In particular, the research infrastructure deployment module 106 may obtain at least one scientific or technical document 102 from a research paper database 130 for analysis and extracts parameters (e.g., dynamic parameters, Courant, Reynolds numbers) from the scientific or technical document, citations to the article, diagrams and links to a code repository. The research infrastructure deployment module 106 may then be configured to determine correspondence between parameters in the text of the article and parameters in the attached code for reconfiguration and analysis. The research infrastructure deployment module 106 may then use LLM to generate a script for creating a computation environment based on the combined requirements and context with suitable parameters of the instance. The research infrastructure deployment module 106 may then perform an assessment of whether the software code corresponds to the scientific or technical document and generates text explaining the results of the comparison using a text generation LLM.

The research infrastructure deployment module 106 may include an optional virtual environment generation module 108, an optional malware module 110, a retrieval module 112, an identification module 113, a machine learning module 114, a comparison module 122, and a UI generation module 124. The research infrastructure deployment module may be connected to a cloud environment 126, software library database 128, research paper database 130, ML model database 132, parameters database 134, and/or a logs database 136. In some aspects, these databases may be hosted on the computing device 104 or a local machine. In some aspects, these databases may be hosted in a cloud environment 126. In some aspects, the research infrastructure deployment module 106 (specifically, the UI generation module 124) may generate a UI for display, which may be part of a client application associated with the research infrastructure deployment module 106. For example, computing device 104 may be a device belonging to an end user such as a researcher or student.

The computing device 104 may execute a UI (not pictured) to obtain, from the user, a scientific or technical document 102 containing at least software code to run the methods, experiments, and/or tests explained in the article and corresponding parameters in the text of the article. For example, if the scientific or technical document corresponds to a chemistry article, the scientific or technical document may include code to execute computer simulations to validate that the method or experiment in the chemistry article. For many users reading the article, they may not understand the software code in the article due to not being computer savvy or the code may be written in a different programing language.

Given the scientific or technical document 102 or a link to the scientific or technical document 102, the machine learning modules 114 from the research infrastructure deployment module 106 may generally perform a three step process to: (1) understand, compare, and/or validate the results and/or code in the scientific or technical document 102 using trained machine learning models (e.g., neural networks, LLMs etc.), (2) understand the logic and parameters of the scientific or technical document 102 and code, and/or (3) generate text explaining the results of the logic and parameters using a text generation large language model (LLM).

In some aspects, the computing device 104 may execute an optional virtual environment generation module 108 configured to generate a suitable and secure computing environment configured to execute software code (e.g., C++, Python, MATLAB, etc.) attached to a scientific or technical document. In some aspects, the optional virtual environment generation module 108 may provide a cloud-based container to compare research articles to the code in the articles. In some examples, the optional virtual environment generation module 108 may provide a virtual machine, a container, a docket container, or a sandbox to compare research articles to the code in the articles.

Optionally, the computing device 104 may execute the optional malware module 110 configured to check the software code for malware and/or security vulnerabilities. Malware may be defined as code (whether it is part of a script or embedded in a software system) designed to cause damage, security breaches, or other threats to application security. In addition, based on a determination that the software code contains malware and/or security vulnerabilities, the optional malware module 110 may be configured to terminate execution of the software code to protect the system from the malware code. Malware code may cause major disruption to the computer and network since hackers can use the malware code to gain control of computers and passwords may be compromised.

In some aspects, the computing device 104 may execute a retrieval module 112 configured to retrieve a scientific or technical document and a software code associated with the scientific or technical document. In some aspects, the retrieval module 112 may access the software library database 128 and/or the scientific or technical documents database. In some aspects, the retrieval module 112 may obtain a description of the subject matter, logic, algorithms, and/or parameters from external sources. In some aspects, the retrieval module 112 may access the scientific or technical documents and the associated software code from the internet or any other suitable sources.

In some aspects, the computing device 104 may execute an identification module 113 configured to identify subject matter, logic, algorithms, and/or parameters from the scientific or technical document. In some aspects, the computing device 104 may execute the identification module 113 configured to identifying subject matter, logic, algorithms, and/or parameters represented in portions of the software code based on the obtained description of the subject matter, logic, algorithms, and/or parameters from external sources.

The computing device 104 may execute a machine learning module 114 including a paper analysis ML model 116, a software analysis ML model 118, and an assessment ML model 120. First, a trained paper analysis ML model 116 is configured to identify subject matter, algorithms, parameters, and/or logic of the scientific or technical document 102 using a text interpretation LLM. Second, a trained SW analysis ML model is configured to analyze software code associated with the scientific or technical document to also identify subject matter, algorithms, parameters, and/or logic of the software code using software code from a software library database 128. Third, an optional trained assessment ML model 120 may be configured to perform the assessment of whether the software code corresponds to the scientific or technical document 102 and generates text explaining the results of the comparison using a text generation LLM.

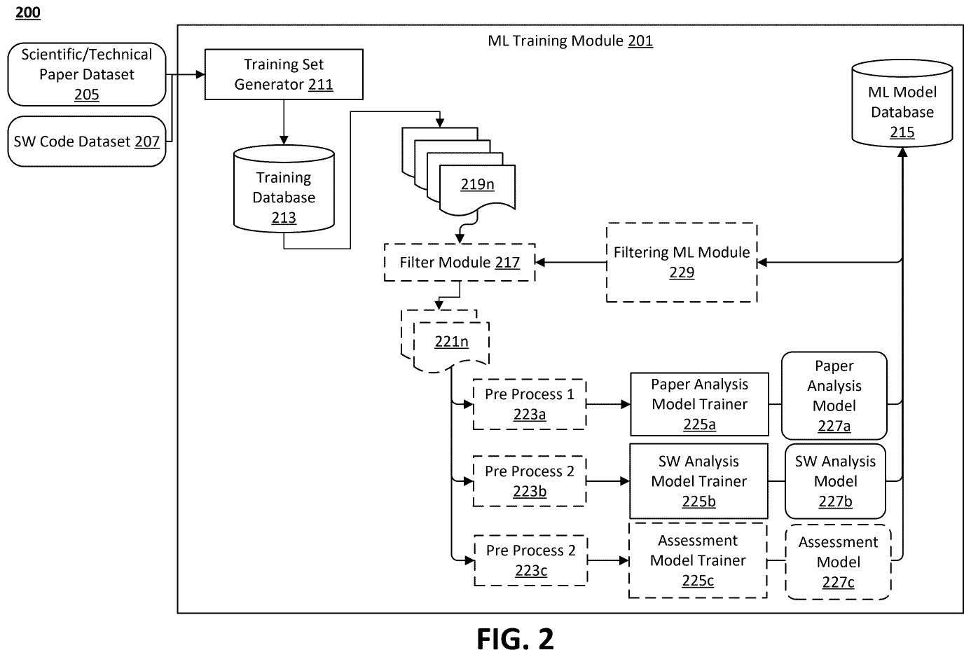

In some aspects, the paper analysis ML model 116, the software analysis ML model 118, and the optional assessment ML model 120 may contain specifically trained LLMs. A LLM is a type of AI designed to understand and generate human language. LLMS are trained on vast amounts of text data, enabling it to perform a wide range of language-related tasks such as answering questions, summarizing text, translating languages, or generating content. LLMS, similar to GPT (generative pretrained transformer), use deep learning techniques to recognize patterns, learn context, and predict word sequences making them highly versatile in natural language processing applications. Accordingly, the LLMs in the paper analysis ML model 116, the software analysis ML model 118, and the optional assessment ML model 120 must first go through training to teach the LLMs to perform their respective specific tasks. Further details about the training of each respective ML model will be described in FIG. 2.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

For LLM tasks such as text summarization, code explanation, code writing, and informational retrieval, an untrained LLM in the paper analysis ML model 116 will first analyze the text from the scientific or technical documents to identify a subject matter, logic, algorithms, and/or parameters by learning and categorizing distinct characteristics that define subject matter, logic, algorithms, and/or parameters. As an example, the training dataset may include labeled training data consisting of scientific or technical documents and their corresponding ground truth labels (e.g., topic, parameters, or logic). Accordingly, since the paper analysis ML model 116 is designed to identify and classify objects from different classes (e.g., each individual topic, parameter, or logic), then the training data will need samples from each topic, parameter, or logic that is to be identified. Typically, thousands of samples from each class may be required.

During training of the LLM, the training dataset comprises data from scientific or technical documents that are input through an untrained LLM model in the paper analysis ML model 116. The results from the untrained LLM are then compared with known data set results using the corresponding topic, parameter, and logic labels identifying each subject matter, logic, algorithms, and/or parameters in the training data. It should be noted that the input to the paper analysis ML model 116 will only be the scientific or technical documents from the training dataset.

For every input training sample from the training dataset, the LLM from the paper analysis ML model 116 will produce a prediction consisting of values representing the probability that the input document corresponds to a given class (e.g., a given subject matter, logic, algorithms, and/or parameter). The output with the highest probability determines the predicted label. A class label for each input document is used to compute a loss (e.g., loss function).

The paper analysis ML model 116 then uses a loss function that quantifies the error between the predicted output and the ground truth (e.g., subject matter label, logic label, algorithm label, and/or parameter label) for a given training sample. In other words, the loss function can be used to guide the learning process by updating the network weights in a way that improves the accuracy of future predictions. This process may continue until the difference between the prediction and the correct targets is minimal.

Once the LLM is trained (e.g., inference), the paper analysis ML model 116 may identify characteristics of subject matter, logic, algorithms, and/or parameters within the text of the scientific or technical documents to identify the topic, parameters, and logic within the text. Specifically, the paper analysis ML model 116 contains a trained LLM configured to perform text classification tasks by leveraging an underlying architecture, typically built on transformer-based models. For example, the LLMS perform text classification by understanding the input context using self-attention mechanisms, extracting semantic meaning, and mapping that to a classification label through a final softmax layer. In addition, fine-tuning is key to making the LLMS effective for specific classification tasks.

During inference, the trained LLM from the paper analysis ML model 116 does not re-evaluate or adjust the layers of the LLM based on the results. Instead, the inference applies knowledge from the trained LLM and uses it to infer a result (e.g., what subject matter the scientific or technical document pertains to, the parameters in the scientific or technical document, the algorithms in the scientific or technical document, or the logic in the scientific or technical document). Accordingly, when a new unknown dataset (e.g., scientific or technical document 102) is input through the trained LLM in the paper analysis ML model 116, the trained LLM outputs a prediction of what subject matter, logic, algorithms, and/or parameters are present in the text of the scientific or technical document 102 based on predictive accuracy of the LLM.

Similar to the paper analysis ML model 116, the trained software analysis ML model 118 is configured to identify characteristics of subject matter, logic, algorithms, and/or parameters within the text of software code associated with the scientific or technical document 102. Accordingly, the explanation of the setup, training, and inference of the trained paper analysis ML model 116 applies to the software analysis ML model 118 in the context of software code rather than scientific or technical documents.

The optional assessment ML model 120 is configured to perform an assessment of whether the software code corresponds to the scientific or technical document and to generate text explaining the results of the comparing using a text generation LLM. For the assessment of whether the software code corresponds to the scientific or technical document, the assessment ML model 120 may use machine learning to compare the software code and the scientific or technical document to determine their similarity, rank, or relationship. As a non-limiting example, the assessment ML model 120 may use a Siamese network to compare the software code and scientific or technical document to compute similarity. The Siamese network may consist of two identical neural networks (with shared weights) that take two inputs and generate embeddings for both. The embeddings are then compared using a similarity metric like cosine similarity or Euclidean distance. As another example, the assessment ML model 120 may use a BERT-based model (transformer model) to compare text by encoding sentences into embeddings and then comparing those embeddings. For this type of assessment, BERT can be fine-tuned on specific tasks like semantic similarity or ranking. As yet another example, the assessment ML model 120 may use a support vector machines (SVMs) with kernels to learn a decision boundary (hyperplane) that separates two classes by maximizing the margin between them. It should be noted that the machine learning models listed above are for illustrative purposes only, and any suitable machine learning model for comparison may be used in the assessment ML model 120.

For generating text explaining the results of the comparing using a text generation LLM, the assessment ML model 120 works by predicting and generating coherent sequences of text based on the input it receives. The core mechanism behind text generation in LLMs also relies on the Transformer architecture, which allows the model to generate contextually relevant text by understanding patterns, meanings, and structures within the input data.

Text generating models are typically pre-trained on massive datasets, such as books, articles, websites, and other text sources. During training, the model learns the statistical relationships between words, phrases, sentences, and broader structures like paragraphs. The goal of the training phase is to learn to predict the next word in a sequence given the previous words. LLMs like GPT are trained using unsupervised learning with a language modeling objective. Specifically, they are trained to minimize the difference between the predicted next word and the actual next word in a sequence of text. Specifically, they are trained to minimize the difference between the predicted next word and the actual next word in a sequence of text. The model sees massive amounts of text data, capturing patterns of grammar, facts, knowledge, and even some logical reasoning. During training, the model learns relationships between words, like which words often follow others, how grammar works, and how various linguistic features (e.g., tense, tone, formality) play out in context.

Before any text is processed, it needs to be tokenized. Tokenization breaks the input text into smaller units, usually subword tokens. Each token is then converted into a numerical vector (embedding) that represents its meaning. These embeddings are used as inputs to the Transformer model. The Transformer architecture, which powers text generation LLMs, uses a mechanism called self-attention to understand the context of the input text. Self-attention allows the model to consider the relationship between every word in the input sequence and all other words, regardless of their distance in the text. This helps the model generate contextually relevant text.

LLMs consist of multiple layers of Transformer blocks, each containing self-attention and feedforward neural networks. As the input text passes through these layers, the model refines its understanding of the context at increasingly abstract levels. Early layers learn basic relationships, such as grammar and word meanings, while deeper layers learn more complex patterns, such as sentence structure, logical relationships, and nuanced meanings. o prevent information loss across layers, residual connections are used to pass information from earlier layers directly to later layers.

When generating text, LLMs work in an auto-regressive fashion, meaning they generate one token at a time, using the previously generated tokens as context for predicting the next token. Once the model has generated all the tokens, the output is decoded back into human-readable text. The final result is a sequence of words, sentences, or even paragraphs that form a coherent response to the input prompt. While LLMs are pre-trained on large amounts of general data, they can be fine-tuned on specific datasets to improve performance for specific tasks like text generation, summarization, or dialogue. Fine-tuning adjusts the model's parameters to better align with a specific task's goals.

The computing device 104 may execute a comparison module 122 configured to identify corresponding algorithms and parameters in the scientific or technical document and the software code. Specifically, the parameter configuration module may compare subject matter, logic, algorithms, and/or parameters of the scientific or technical document with the subject matter, logic, algorithms, and/or parameters of the associated software code in order to identify corresponding subject matter, logic, algorithms, and/or parameters between the scientific or technical document and the software code.

The computing device 104 may execute a configuration module (not pictured) configured to adjust parameters or values of the parameters in the software code. Specifically, the parameter configuration module may generate prompts based on the parameters of the code and create a script for changing parameters in terms of the software code. After the parameters or values of the parameters are adjusted, the code may be re-executed with the updated parameters and the results are re-analyzed.

The computing device 104 may execute a UI generation module 124 configured to receive inputs from a user and display, in a UI, corresponding algorithms and parameters in the scientific or technical document and the software code. In some aspects, the UI may also display computer-generated text explaining the results of the comparison.

It should be noted that the identification of subject matter, parameters, and/or logic of the scientific or technical document and corresponding software code is heavily simplified. One of skilled win the art will appreciate that the machine learning models utilized may have significantly large datasets with highly specific details. For example, there may be hundreds of parameters in each scientific or technical document. The analysis would be beyond the capabilities of the human mind because the amount of data to be identified and analyzed in each scientific or technical document is unfathomable.

FIG. 2 is a block diagram illustrating a system for training machine learning models to identifying logic, algorithms, and/or parameters of scientific or technical documents and associated software code.

As shown in example 200, a machine learning training module 201 is configured to build and train specialized machine learning models with inference to perform particular tasks. In this way, the specialized machine learning models may develop an ability to perform particular objectives within new data that is not part of a training dataset. By subjecting the specialized machine learning models to large amounts of unlabeled and/or labeled trained data sets, the specialized machine learning models may perform particular tasks such as identifying subject matter, parameters, algorithms and/or logic in the scientific or technical document and corresponding software code, perform an assessment of whether the software code corresponds to the scientific or technical document, and/or generate text explaining the results of the comparison using a text generation LLM.

Supervised learning is effective for tasks such as classification (assigning inputs to predefined categories) and regression (predicting continuous values) since it relies on the availability of labeled data for both training and evaluation phases. In supervised learning, the machine learning training module 201 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment.

In the training phase, the machine learning training module 201 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the machine learning training module 201 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the machine learning training module 201 contains at least a training database 213 configured to store the raw training data 219n and corresponding labels, a machine learning model database 215 to store the trained models (e.g., paper analysis model 227a, software analysis model 227b, and/or assessment model 227b). In some aspects, the machine learning training module 201 may contain an optional filtering machine learning model 229 and an optional filter module 217 configured to filter data from the training database 213 for training by removing bad training data.

Training data from the research paper dataset 205 and software code dataset 207 is received into the machine learning training module 201 via the training set generator 211. In some aspects, a research paper dataset 205 may include scientific or technical documents with logic, algorithms, and/or parameters and corresponding software code. In some aspects, the software code dataset 207 may include software code and corresponding logic, algorithms, and/or parameters.

An optional filter module 217 is configured to filter out bad training data in order to claim up the training data in the training dataset 219n. In some examples, the optional filter module 217 may be a neural network. In some examples, the optional filter module 217 is a simple mathematical model. In some examples, the cleaned training dataset 221n then undergoes optional preprocessing steps depending on which neural network or model is being trained.

The optional preprocess 1 424a, preprocess 2 424b, and preprocess 3 424c are automated processes that modify the raw data received from 219n (or cleaned training dataset 221n) and prepare the raw data as input to the respective model trainers (e.g., a paper analysis model trainer 225a, a software analysis model trainer 225b, and an assessment model trainer 225b). These may be described in the machine learning training module 201 as snippets of code that prepares the datasets. In some examples, the preprocessing module (e.g., preprocess 1 223a, preprocess 2 223b, and preprocess 3 223c) for a particular trainer may be an automated script or code that will be setup the first time any model is trained.

The paper analysis model trainer 225a, the software analysis model trainer 225b, and the optional assessment model trainer 225c are the scripts or code that train the model. The paper analysis model trainer 225a, the software analysis model trainer 225b, and the optional assessment model trainer 225c may be a script or code that holds the instructions on how a model should be trained (e.g., optimization method, model architecture, dataset division, etc.) and also runs the training. The paper analysis model trainer 225a, the SW analysis model trainer 225b, and the optional assessment model trainer 225c each take as input the raw or filtered processed training data and train the paper analysis model 227a, the software analysis model 227b, and the optional assessment model 227c to achieve their specific objectives, respectively.

In summary, the raw dataset 219n or cleaned dataset 221n may optionally go through different preprocessing steps 223a, 223b, and 223c and then a corresponding paper analysis model trainer 225a, a software analysis model trainer 225b, and an assessment model trainer 225c to generate a trained paper analysis model 227a, a software analysis model 227b, and an assessment model 227c. In some examples, each of these models may be a LLM.

The LLMs are trained through a multi-step process involving vast amounts of text data and sophisticated machine learning techniques. The training generally occurs in three stages: pre-training, fine-tuning, and scaling. The first step generally includes data collection since LLMs require massive amounts of text data to learn the patterns, structures, and relationships in language. The goal is to expose the model to a wide variety of text forms, genres, and topics to help it generalize well to different contexts. In the pre-training phase, the model is then trained on a large corpus of text in an unsupervised manner, typically using self-supervised learning techniques. The most common training objective is language modeling. The training may be done using a neural network architecture called the transformer, which excels at capturing long-range dependencies in text. Pre-training allows the model to learn grammar, facts about the world, and how language is structured.

Key components during the pre-training phase include: a transformer architecture, an attention mechanism, and tokenization. A transformer architecture may be composed of layers of self-attention mechanisms and feed-forward networks, which enable the model to focus on different parts of the input. Next, attention mechanism allows the model to weigh the importance of different words in the context of others, helping it understand relationships in text better than traditional models. Text is then broken into smaller units (e.g., tokens), like words or subwords, to make it easier for the model to process.

After pre-training, the model undergoes fine-tuning to adapt it to more specific tasks, such as question answering, summarization, or chatbot interaction. Fine-tuning uses smaller, task-specific datasets and often involves supervised learning. The model may be exposed to labeled data where inputs (e.g., questions) are paired with expected outputs (e.g., answers) so it can adjust its internal parameters to better perform on that specific task. During training, the model's predictions are compared to the correct answers, and the differences (errors) are minimized using a loss function like cross-entropy loss. The model's parameters are updated via optimization algorithms like stochastic gradient descent (SGD) or its variants (e.g., Adam optimizer) to reduce the loss and improve performance.

Once the LLMs are set up, LLMs may be scaled by using more data such as pre-training on larger datasets to improve generalization. LLMs also use hundreds of billions of parameters, increasing their capacity to capture complex language relationships. Models may also be trained for millions of iterations on powerful distributed hardware (e.g., GPUs, TPUs) to refine their internal representations.

The raw training dataset 219n used for training may contain noise and bad training images from the training database 213. Accordingly, to create a clean and filtered training dataset, the optional filter module 217 is configured to filter out unwanted data points from the raw training dataset 219n by developing smaller, less accurate systems based on patterns and metadata information. For example, an automated system may be created to identify different subjects, parameters, algorithms, and/or logic using a trained paper analysis model 227a to analyze different scientific or technical documents. The resulting training dataset 221n may consist of scientific or technical documents and labels, where each scientific or technical document contains labeled subjects, parameters and/or logic.

When a new model (e.g., a trained paper analysis model 227a, a software analysis model 227b, and an optional assessment model 227c) is created, and a new process for filtering and automated labeling is established, it is added to the machine learning model database 215 in the machine learning training module 201. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a simple mathematical model.

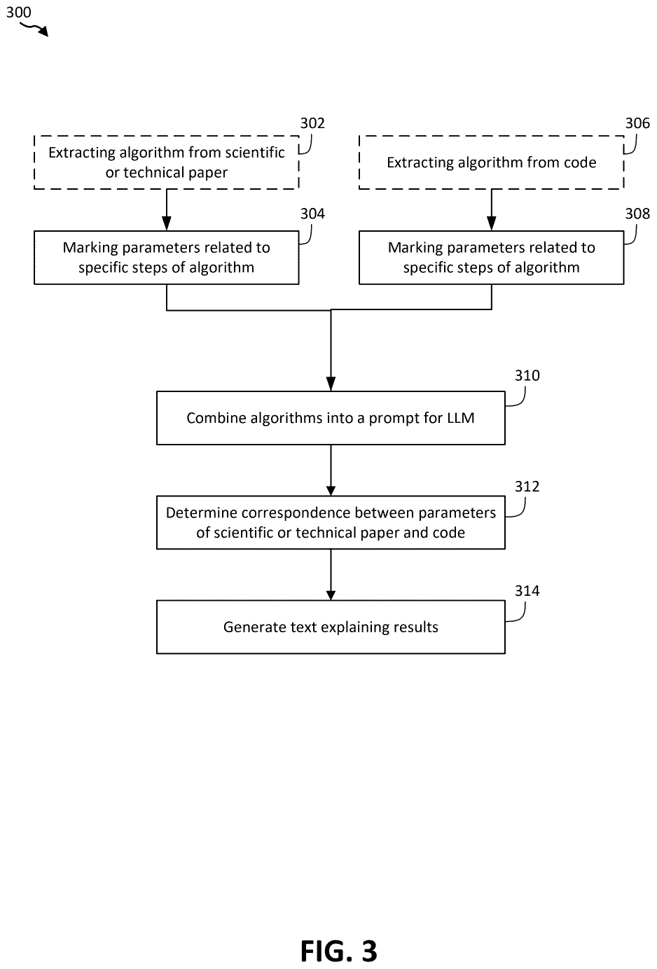

FIG. 3 is a flow diagram of a method for finding correspondence between parameters according to aspects of the present disclosure. In various implementation, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory).

Optionally, at 302, the method 300 includes extracting an algorithm (or logic) from a scientific or technical document. Optionally, at 304, the method 300 includes marking parameters related to specific steps of the algorithm. In some aspects, the method 300 includes identifying scientific features such as names of algorithms and parameters from the scientific or technical document and obtaining descriptions of the algorithms and parameters from external sources. In some aspects, the method 300 may include marking parameters from the scientific or technical document, citations in the scientific or technical document, and diagrams in the scientific or technical document.

At 306, the method 300 includes extracting algorithm from software code associated with the scientific or technical document. At 308, the method 300 includes marking parameters related to specific steps of the algorithm.

At 310, the method 300 includes combining the algorithms into a prompt for a LLM. In some aspects, this step may include using the LLM to find correspondence between parameters in the scientific or technical document and in the corresponding software code.

At 312, the method 300 includes determining a correspondence between parameters of the scientific or technical document and the software code. This step is necessary because the scientific or technical document may use one set of parameters and values and the software code may use a different set of parameters and values. In this way, the logic of the code may be understood such that each parameter in the scientific or technical document has a mapping to a parameter in the software code.

In some aspects, context may be uploaded for finding correspondence between parameters by a human or via a LLM.

At 314, the method 300 includes generating text explaining results of the correspondence. In this way, a user may understand the logic of the article and code and understand what each parameter means.

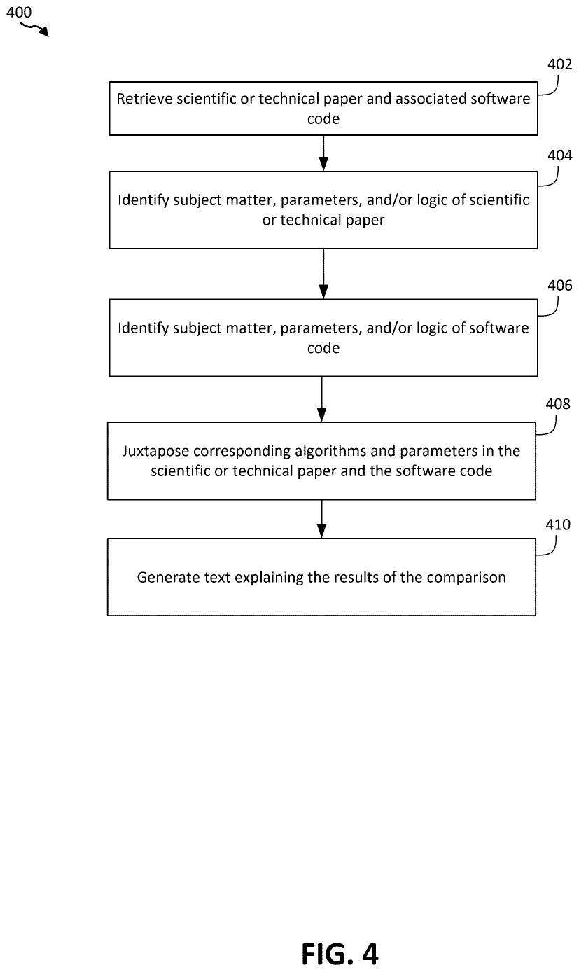

FIG. 4 is a flow diagram of a method for machine learning (ML)-assisted analysis of scientific or technical documents and associated software code according to aspects of the present disclosure. In various implementation, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 includes at least analyzing a scientific or technical document and software code associated with the scientific or technical document to create a correspondence between subject matter, logic, algorithms, and/or parameters in the text of the scientific or technical document and parameters in the software code for analysis and/or reconfiguration.

One of the key principles of scientific research is verification and reproducibility, meaning that other researchers should be able to replicate the results described in the scientific or technical document. By providing an accompanying computer code, researchers provide transparency and enable others to verify their findings or build on their work. This is especially important in field like computational sciences, machine learning, and bioinformatics.

At 402, the method 400 may include retrieving a scientific or technical document and a software code associated with the scientific or technical document. The software code may include executable code and/or source code. In some aspects, the method 400 may include retrieving a link to the software code and run the software code in a dedicated, secure computing environment for analyzing logic and/or parameters of the software code. As an example, referring back to FIG. 1, a retrieval module 112 may be configured to retrieve a scientific or technical document and a software code associated with the scientific or technical document.

In some aspects, the method 400 may include extracting parameters (e.g., dynamic parameters, Courant, Reynolds numbers, etc.) from the scientific or technical document, citations in the scientific or technical document, diagrams in the scientific or technical document, and links to the code repository.

At 404, the method 400 may include identifying scientific features including at least one of subject matter, logic, algorithms, and/or parameters represented in the scientific or technical document by analyzing the scientific or technical document by analyzing the scientific or technical document for the scientific features. In some aspects, the scientific features comprise at least data structures, functions and variable of the functions.

Optionally, method 400 may include analyzing the scientific or technical document using a trained paper analysis ML model configured to identify the scientific features represented in the scientific or technical document. In some aspects, the scientific features may include logic, algorithms, and/or parameters of the scientific or technical document that comprise at least data sets, equations and parameters of the equations. As an example, referring back to FIG. 1, a trained paper analysis ML model may be configured to identify scientific features including at least one of subject matter, algorithms, parameters, and/or logic of the scientific or technical document 102 using a text interpretation LLM.

In some aspects, the method 400 may include preparing the paper analysis ML model based on a text interpretation large language model to identify different subject matter, logic, algorithms, and/or parameters using one or more other scientific or technical documents from a research paper database. This may involve leveraging techniques from natural language processing (NLP), program analysis, and machine learning. Once the paper analysis ML model is sufficiently trained and validated, the paper analysis ML model may be deployed as a service (API) or integrated into a larger code analysis tool or development environment.

In some aspects, the method 400 may include preparing the software analysis ML model to identify different subjects, parameters, and/or logic using one or more software code from a code database.

In some aspects, identifying the corresponding scientific features represented in the analyzed software code is based at least in part on searching for scientific features in the software code using the trained software analysis ML model.

In some aspects, searching for the scientific features in the software code further comprises: obtaining partial algorithms in the scientific or technical document and the software code; identifying scientific features in the partial algorithms in the software code that are similar to the identified scientific features of the partial algorithms in the scientific or technical document; juxtaposing the scientific features found in the partial algorithms in the scientific or technical document and in the partial algorithms in the software code; and determining similarities between the scientific features found in the partial algorithms in the scientific or technical document and partial algorithms in the software code.

In some aspects, searching for scientific features in the software code further comprises: benchmarking the results of the search and displaying a level of confidence corresponding to a similarity of each identified methodology feature represented in the software code with the identified methodology feature represented in the scientific or technical document.

Optionally, in some aspects, the method 400 may include identifying corresponding parameters in the scientific or technical document and the software code by juxtaposing the scientific features of the scientific or technical document with the features of algorithms and parameters of the associated software code; and displaying, in the user interface, at least the identified corresponding parameters in the scientific or technical document and the software code.

At 406, the method 400 may include obtaining a description of the identified scientific features from external sources. In some aspects, the method 400 may include displaying the description of the scientific features to the user for confirmation.

Optionally, the method 400 may include analyzing portions of the software code using a trained software analysis ML model configured to identify scientific features from the scientific or technical document in the software code using a trained software analysis ML model configured to identify the corresponding scientific features represented in the analyzed software code based on the obtained description of the identified scientific features represented in the scientific or technical document. The portions of the software code being identified based on external sources. As an example, referring back to FIG. 1, a trained software analysis ML model 118 may be configured to analyze software code associated with the scientific or technical document to also identify subject matter, algorithms, parameters, and/or logic of the software code using software code from a software library database 128.

As an example, if a methodology feature such as Reynolds number is identified in the article and then a comment in the corresponding software code indicating a “Reynolds number” alongside a variable named “RNDN”, then the software analysis ML model 118 can infer that the RNDN variable pertains to the Reynolds number. Alternatively, if a variable itself is named “ReynoldN”, then the software analysis ML model 118 may correctly predict that the variable “ReynoldN” relates to the Reynolds number.

In some aspects, the method 400 may include training the software analysis ML model to identify different subject matter, logic, algorithms, and/or parameters using one or more software code from a code database. To analyze software code using the trained software analysis ML model, the software code may be preprocessed, run inference with the trained software analysis ML model, and interpret the output including at least identification of subject matter, logic patterns, specific algorithms and/or parameters used in the software code. By interpreting and visualizing the trained software analysis ML model's output, the method 400 may generate detailed insights into the code structure and functionality.

In some aspects, analyzing the software code may include: generating a secure virtual environment configured to execute software code; and executing the software code in the secure virtual environment. In some aspects, the security virtual environment may include one of a virtual machine, a container, or a sandbox. As an example, referring back to FIG. 1, an optional virtual environment generation module 108 may be configured to generate a suitable and secure computing environment configured to execute software code (e.g., C++, Python, MATLAB, etc.) attached to a scientific or technical document.

Generating and executing software code in a secure virtual environment offers a wide range of benefits, including improved security, isolation, and reproducibility, as well as efficient resource management. These environments help protect the host system from potential risks, streamline dependency management, facilitate testing and debugging, and enhance portability across platforms. For developers, testers, and system administrators, virtual environments provide a safe and consistent way to execute code, ensuring that software runs reliably in various configurations while minimizing risk to the host system.

In some aspects, executing the software code may include: retrieving and utilizing one or more software libraries for the execution of the software code. The software libraries help execute, manage, and even secure code, offering environments for testing, development, deployment, or scripting. These software libraries and frameworks provide various methods for executing code across multiple domains, whether for testing, development, high-performance computing, or large-scale data processing. The appropriate tool may be selected depending on requirements (e.g., secure execution, distributed processing, or containerized environments) to ensure efficient and secure code execution.

In some aspects, executing the software code may include: checking the software code for malware and/or security vulnerabilities; and based on a determination that the software code contains malware and/or serious security vulnerabilities, terminating execution of the software code. As an example, referring back to FIG. 1, an optional malware module 110 may be configured to check the software code for malware and/or security vulnerabilities, and, based on a determination that the software code contains malware and/or security vulnerabilities, the optional malware module 110 may be configured to terminate execution of the software code to protect the system from the malware code.

In some aspects, the method 400 may further include uploading context for configuring the secure virtual environment and/or finding correspondence between parameters by an agent (e.g., human or LLM). This may include at least: finding the project on a code repository (e.g., GitHub), recognizing the programming language of the project, defining parameters for the code, environment, and requirements, recognizing the programming language of the project, searching for descriptions of libraries, gathering additional information from similar projects, handling voice input to check the sufficiency of requirements and parameters; and using the LLM to ask users additional questions about other requirements and parameters.

In some aspects, a LLM may be used to generate a script for creating a computational/virtual environment (VM) based on the combined requirements and context with suitable parameters of the instance (e.g., GPU, CPU, ARM, memory, disk, versions, or other requirements). The computational/VM is a software environment that allows users to run and test code or simulations in an isolated, controlled space, separate from the main system environment. This isolation helps in managing dependencies, libraries, and settings specific to a project or task without affecting or conflicting with other environments on the system. Next, an instance (e.g., container) may be generated for processing the code based on the parameters. Containers are lightweight environments that package code, libraries, and dependencies together.

At 408, the method 400 may include juxtaposing subject matter, logic, algorithms, and/or parameters of the scientific or technical document with the subject matter, logic, algorithms, and/or parameters of the associated software code to identifying corresponding subject matter, logic, algorithms, and/or parameters in the scientific or technical document and the software code. As an example, referring back to FIG. 1, a comparison module 122 may be configured to identify corresponding algorithms and parameters in the scientific or technical document and the software code by comparing subject matter, logic, algorithms, and/or parameters of the scientific or technical document with the subject matter, logic, algorithms, and/or parameters of the associated software code in order to identify corresponding subject matter, logic, algorithms, and/or parameters between the scientific or technical document and the software code.

In some aspects, identifying the correspondence between the software code and the scientific or technical document further comprising: preparing and executing an assessment ML model to perform the assessment of whether the software code corresponds to the scientific or technical document, based on a training dataset comprising scientific or technical documents and corresponding software code, and to generate text explaining the results of the comparison using a text generation large language model (LLM). As an example, referring back to FIG. 1, an optional trained assessment ML model 120 may be configured to perform the assessment of whether the software code corresponds to the scientific or technical document 102 and generates text explaining the results of the comparison using a text generation LLM.

In some aspects, assessing whether the software code corresponds to the scientific or technical document further comprises: extracting scientific features from the scientific or technical documents and corresponding software code; marking parameters from the scientific or technical documents related to specific steps of the extracted features; combining the algorithms from the scientific or technical documents and the algorithms from the corresponding software code into prompts for the trained assessment ML model; and determining correspondences between the extracted parameters and corresponding values from text of the scientific or technical documents and parameters and corresponding values from the corresponding software code using the trained assessment ML model.

At 410, the method 400 may include displaying, in a user interface, at least the corresponding scientific features from the scientific or technical document and the software code. In this way, a user may confirm or correct the identified parameters between the scientific or technical document and the software code. As an example, referring back to FIG. 1, UI generation module 124 configured to receive inputs from a user and display, in a UI, corresponding algorithms and parameters in the scientific or technical document and the software code.

In some aspects, the method 400 may include displaying, in the user interface, parameters in the software code using a visual indicator configured to accept, deny, or edit correspondence. This allows a user to easily view and find where particular parameters are presented in the software code.

In some aspects, the method 400 may further include: obtaining a modification of at least one parameter in the software code; and executing the software code with the modified at least one parameter. In this way, a user may find and correct an incorrect parameter in the software code and re-execute the computer code with the modified parameter. A user may modify a parameter by using language commands, configuration files, or any suitable means.

In some aspects, the method 400 may include allowing a user to change parameters in the software code. As an example, the user may modify the variables and observe the impact on the calculation results. As another example, a Reynolds number may be found in the software code and the user can change the value of the Reynolds number within the UI to re-execute the code with a different parameter. A user may want to change the Reynolds number in the software code and re-execute the code for a variety of reasons, particularly related to exploring fluid dynamics, validating results, or studying new scenarios. As an example, the user may want to explore fluid behavior at different flow regimes and since the Reynolds number is a critical parameter in determining whether the flow is laminar, turbulent, or in transition-changing it allows the user to study how fluid behavior evolves across these regimes. Users might want to investigate Reynolds numbers beyond those analyzed in the paper to explore new flow conditions or phenomena. As another example, the user may want to determine the impact of the Reynolds number such that by changing the Reynolds number, the user can study how sensitive a system's behavior (e.g., drag, heat transfer, or mixing) is to changes in flow characteristics. As yet another example, a user may want to validate computational or theorical results against experimental data that involves different Reynolds numbers. Users may also need to reproduce the findings of a scientific paper by running simulations at the same or similar Reynolds numbers used in the study.

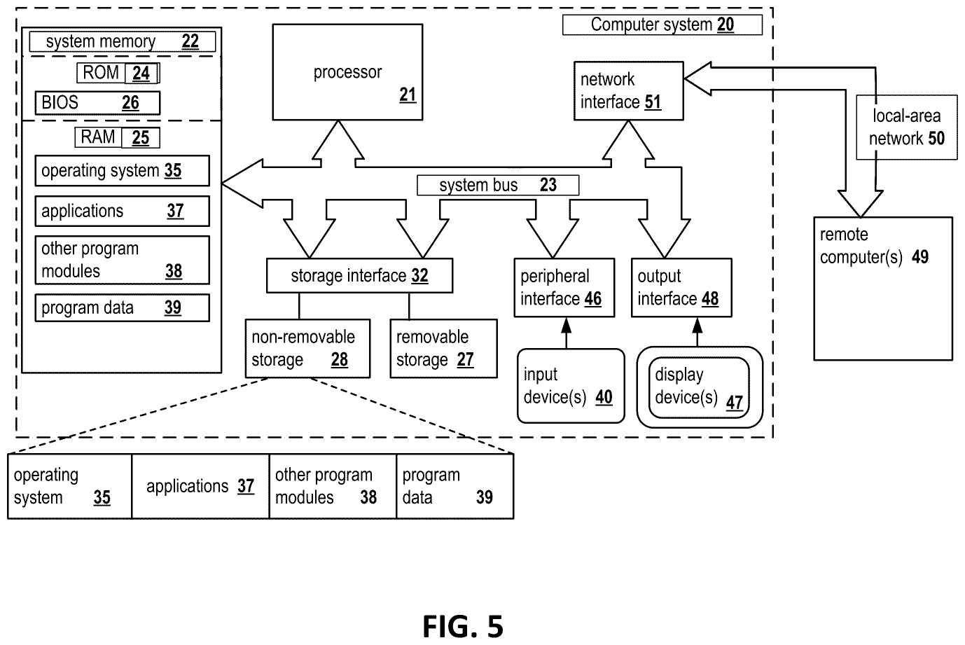

FIG. 5 is a block diagram illustrating a computer system 20 on which aspects of systems and methods machine learning (ML)-based analysis of multiple simultaneous events in a video may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for machine learning (ML)-assisted analysis of scientific or technical documents and associated software code, the method comprising:
retrieving a scientific or technical document and a software code associated with the scientific or technical document, wherein the software code comprises executable code and/or source code;
analyzing the scientific or technical document for scientific features including at least one of parameters, subject matter, logic, or an algorithm using a trained paper analysis ML model configured to identify the scientific features represented in the scientific or technical document;
obtaining a description of the identified scientific features represented in the scientific or technical document from external sources;
analyzing the software code to identify corresponding scientific features from the scientific or technical document in the software code using a trained software analysis ML model configured to identify the corresponding scientific features represented in the analyzed software code based on the obtained description of the identified scientific features represented in the scientific or technical document ; and
displaying, in a user interface, the identified corresponding scientific features from the scientific or technical document and the software code.

2. The method of claim 1, wherein identifying the corresponding scientific features represented in the analyzed software code is based at least in part on searching for scientific features in the software code using the trained software analysis ML model.

3. The method of claim 2, wherein searching for scientific features in the software code further comprises:
obtaining partial algorithms in the scientific or technical document and the software code;
identifying scientific features in the partial algorithms in the software code that are similar to the identified scientific features of the partial algorithms in the scientific or technical document ;
juxtaposing the scientific features found in the partial algorithms in the scientific or technical document and in the partial algorithms in the software code; and
determining similarities between the scientific features found in the partial algorithms in the scientific or technical document and partial algorithms in the software code.

4. The method of claim 2, wherein searching for scientific features in the software code further comprises:
benchmarking the results of the search and displaying a level of confidence corresponding to a similarity of each identified methodology feature represented in the software code with the identified methodology feature represented in the scientific or technical document.

5. The method of claim 1, further comprising:
identifying corresponding parameters in the scientific or technical document and the software code by juxtaposing the scientific features of the scientific or technical document with the features of algorithms and parameters of the associated software code; and
displaying, in the user interface, at least the identified corresponding parameters in the scientific or technical document and the software code.

6. The method of claim 1, further comprising:
analyzing portions of the software code using the trained software analysis ML model configured to identify subject matter, logic, algorithms, and/or parameters represented in the portions of the software code, wherein the portions of the software code are identified based on the external sources.

7. The method of claim 1, further comprising:
displaying the description of the scientific features from external sources.

8. The method of claim 5, wherein the algorithms and parameters of the scientific or technical document comprise at least data sets, equations and parameters of the equations and the algorithms and parameters, represented in the software code include data structures, functions and variable of the functions.

9. The method of claim 1, wherein analyzing the software code further comprises:
generating a secure virtual environment configured to execute software code; and
executing the software code in the secure virtual environment.

10. The method of claim 9, wherein executing the software code comprises:
retrieving and utilizing one or more software libraries for the execution of the software code.

11. The method of claim 9, wherein executing the software code comprises:
checking the software code for malware and/or security vulnerabilities; and
based on a determination that the software code contains malware and/or serious security vulnerabilities, terminating execution of the software code.

12. The method of claim 1, further comprising:
preparing the paper analysis ML model to identify the scientific features using one or more other scientific or technical documents from a research paper database.

13. The method of claim 1, further comprising:
preparing the software analysis ML model to identify different subjects, parameters, and/or logic using one or more software code from a code database.

14. The method of claim 1, identifying the correspondence between the software code and the scientific or technical document further comprising:
preparing and executing an assessment ML model to perform the assessment of correspondence to the scientific or technical document, based on a training dataset comprising scientific or technical documents and corresponding software code, and to generate text explaining the results of the comparison using a text generation model.

15. The method of claim 14, wherein assessing whether the software code corresponds to the scientific or technical document further comprises:
extracting scientific features from the scientific or technical documents and corresponding software code;
marking parameters from the scientific or technical documents related to specific steps of the extracted features;
combining the algorithms from the scientific or technical documents and the algorithms from the corresponding software code into prompts for the trained assessment ML model; and
determining correspondences between the extracted parameters and corresponding values from text of the scientific or technical documents and parameters and corresponding values from the corresponding software code using the trained assessment ML model.

16. The method of claim 1, further comprising:
displaying, in the user interface, parameters in the software code using a visual indicator configured to accept, deny, or edit correspondence.

17. The method of claim 1, further comprising:
obtaining a modification of at least one parameter in the software code; and
executing the software code with the modified at least one parameter.

18. The method of claim 1, further comprising:
allow a user to change parameters in the software code.

19. A system for machine learning (ML)-based execution of scientific or technical documents and associated software code, the system comprising:
at least one memory; and
at least one hardware processor coupled with the at least one memory and configured, individually or in combination, to:
retrieve a scientific or technical document and a software code associated with the scientific or technical document, wherein the software code comprises executable code and/or source code;
analyze the scientific or technical document for scientific features including at least one of parameters, subject matter, logic, or an algorithm using a trained paper analysis ML model configured to identify the scientific features represented in the scientific or technical document;
obtain a description of the identified scientific features represented in the scientific or technical document from external sources;
analyze the software code to identify corresponding scientific features from the scientific or technical document in the software code using a trained software analysis ML model configured to identify the corresponding scientific features represented in the analyzed software code based on the obtained description of the identified scientific features represented in the scientific or technical document; and
cause, in a user interface, a display of the identified corresponding scientific features from the scientific or technical document and the software code.

20. A non-transitory computer readable medium storing thereon computer executable instructions for machine learning (ML)-assisted analysis of scientific or technical documents and associated software code, including instructions for:
retrieving a scientific or technical document and a software code associated with the scientific or technical document, wherein the software code comprises executable code and/or source code;
analyzing the scientific or technical document for scientific features including at least one of parameters, subject matter, logic, or an algorithm using a trained paper analysis ML model configured to identify the scientific features represented in the scientific or technical document;
obtaining a description of the identified scientific features represented in the scientific or technical document from external sources;
analyzing the software code to identify corresponding scientific features from the scientific or technical document in the software code using a trained software analysis ML model configured to identify the corresponding scientific features represented in the analyzed software code based on the obtained description of the identified scientific features represented in the scientific or technical document; and
causing, in a user interface, a display of the identified corresponding scientific features from the scientific or technical document and the software code.
